(19) United States
(12) Patent Application Publication
(10) Pub. No.: US 2008/0052526 A1
(43) Pub. Date: Feb. 28, 2008

(54) System and Method for Enrolling Users in a Pre-Boot Authentication Feature

(76) Inventors: James E. Dailey, Round Rock, TX (US); Gregory Hudgins, Pflugerville, TX (US); Alok Pant, Cedar Park, TX (US); Benjamen G. Tyner, Austin, TX (US)

Correspondence Address: HAMILTON & TERRILE, LLP, P.O. BOX 203518, AUSTIN, TX, 78720, US

(21) Appl. No.: 11/456,246

(22) Filed: Jul. 10, 2006

(51) Int. Cl. H04K 1/00

(52) U.S. Cl. 713/186

(57) ABSTRACT

An authentication method set forth which includes an interface that can be used by operating system level software to verify and set various hardware level passwords, like the BIOS boot password and hard disk password. The method further specifies an application behavior that allows an operating system level pre-boot authorization (PBA) enrollment application to set and verify and make use of any hardware level passwords that are needed for PBA enrollment.

### BACKGROUND OF THE INVENTION

1. Field of the Invention

The present invention relates in general to the field of information handling system password protection, and more particularly to a system and method for enrolling users in a pre-boot authentication feature.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One concern with the use of information handling systems is the security of information stored or processed by an information handling system. Businesses often have confidential and sensitive information, such as customer lists and identities, that are stored on information handling systems which, if compromised, could lead to business difficulties or customer complaints. Individuals typically maintain private and financial information, such as medical and financial records, that are stored on information handling systems which, if compromised, could lead to embarrassment of or theft from the individual. To secure information, businesses and individuals typically invest in a variety of security applications that prevent access by unauthorized users, such as network password protection and firewalls. A cat-and-mouse game is often played between information technology administrators seeking to protect information and hackers seeking to illicitly acquire information. Often, security measures taken to secure information impact legitimate users with delays or inconveniences in using the information. For instance, users are typically required to have a password to access a network. If a user forgets the password or compromises the password, a network administrator generally must get involved to allow the user access to the network, such as by retrieving or changing the password.

One security risk that presents a particular danger to information is the physical theft of an information handling system. Desktop systems are generally kept in a physically secure area that makes theft difficult; however, laptop or portable systems are often exposed in non-secure areas that make them vulnerable to theft. For instance, businesses often supply portable systems to employees who travel frequently. These portable systems are often configured to connect with the business' network through the Internet or through a cradle located in the employee's office. Thus, physical theft of a portable system can expose the entire business' network to attack by exposing security information that allows remote access to the network. Individuals also often use portable systems to store private information that is subject to disclosure if the system is stolen. To counter the risk of physical theft, portable systems are generally protected by one or more passwords. For instance, hard disk drives have both a user password and a master password to access information. The user selects the user password for daily use while the master password allows access if the user loses or forgets the user password. Similarly, the basic input output system (BIOS) of the information handling system often includes user and administrator password protection to limit access to the information handling system to an authorized user or administrator. If a user forgets a password, information technology administrators need access to the administrator password of the BIOS and the master password of the hard disk drive to access the system. However, if the master password of the hard disk drive is changed from its manufacture setting, the manufacturer of the information handling system cannot aid in the retrieval of the lost password. Because the irretrievable loss of a hard disk drive password is the equivalent from the user's perspective of a hard disk drive failure and often leads to service calls or system returns that increase a manufacturer's cost, information handling system manufactures typically enable one password for the user and retain the other password as a failsafe to use in response to a loss of a user password.

One known method for facilitating the use of passwords and security is a basic input output system (BIOS) based Pre-Boot Authentication (PBA) process. With known BIOS based Pre-Boot Authentication (PBA) process, a user's fingerprint or fingerprints are stored in a scanner database for use in authorizing access to the information handling system. See for example, FIG. 1, labeled Prior Art. With the known BIOS based PBA process, a user may often be forced to take actions on the first boot after the enrollment to complete the enrollment process. For example, referring to FIG. 2, labeled prior art, when a user begins enrollment in the PBA process, the information handling system scans a fingerprint of a user and locates a finger print within the scanner database at step 210 and the process for the BIOS and hard disk drive (HDD) passwords is repeated. More specifically, the scanner database is searched to determine whether the database entry includes a corresponding password at step 220. If the entry does not include a password, then the user is prompted for the password at step 222. If the entry contains a password, then the password is checked to determine whether the password is current at step 224. If the password is not current, then again, the user is prompted for a password at step 222. After the password is entered, if the password is correct as determined at step 230, then the password is stored within the corresponding entry of the scan database at step 232 and the authentication completes. If the password is incorrect as determined at step 230, the access to the information handling system is denied at step 240. Accordingly, the known PBA process does not completely enroll users during the initial PBA process.

Because the user attempts to enable a new boot-time authentication method, but is not completely able to use the new method on the subsequent boot, an unfavorable user experience is created, as the user is forced to continue to enter an old password on the next boot. This requirement during the subsequent boot can also lead to confusion and a lack of confidence in the new authentication method.

### SUMMARY OF THE INVENTION

In accordance with the present invention, an authentication system and method is set forth which includes an interface that can be used by operating system level software to verify and set various hardware level passwords, like the BIOS boot password and hard disk password. The method further specifies an application behavior that allows an operating system level PBA enrollment application to set and verify and make use of any hardware level passwords that are needed for PBA enrollment.

Thus, using the authentication method in accordance with the present invention, once the user completes the operating system level enrollment program and reboots, the user can immediately begin using the new PBA authentication method. The user does not need to enter any hardware level passwords again as long as they conform to the newly authorized authentication method such as an appropriate smartcard or fingerprint. Furthermore, if the user registers multiple fingers, the user can use any of them at any time in the future without ever needing to enter a system or hard-drive password. Thus the user has a better experience, and the process for authenticating the user is much simpler

More specifically, in one embodiment, the invention relates to an information handling system which includes a processor, memory coupled to the processor and an authentication system stored on the memory. The authentication system includes an enrollment portion and an authentication portion. The enrollment portion includes instructions configured to access an authentication identifier of a user, receive a password from the user, associate the authentication identifier with the password during enrollment, and store a key indicating the association within an authentication database. The authentication portion includes instructions configured to access the authentication identifier of the user, access the authentication database to determine whether a key indicating the association is present, and permit access to the information handling system when the key is present.

In another embodiment, the invention relates to a method for performing a pre-boot authentication process for an information handling system which includes performing an enrollment process on the information handling system and performing an authentication process during subsequent accesses to the information handling system. The enrollment process includes accessing an authentication identifier of a user, receiving a password from the user, associating the authentication identifier with the password during enrollment, and storing a key indicating the association within an authentication database. The authentication process includes accessing the authentication identifier of the user, accessing the authentication database to determine whether a key indicating the association is present, and permitting access to the information handling system when the key is present.

In another embodiment, the invention relates to an apparatus for performing a pre-boot authentication process for an information handling system which includes means for performing an enrollment process on the information handling system and means for performing an authentication process during subsequent accesses to the information handling system. The means for performing the enrollment process includes means for accessing an authentication identifier of a user, means for receiving a password from the user, means for associating the authentication identifier with the password during enrollment, and means for storing a key indicating the association within an authentication database. The means for performing the authentication process includes means for accessing the authentication identifier of the user, means for accessing the authentication database to determine whether a key indicating the association is present, and, means for permitting access to the information handling system when the key is present.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled prior art, shows a flow chart of an authentication method.

FIG. 2, labeled prior art, shows a more detailed flow chart of a known authentication method.

FIG. 3 shows a system block diagram of an information handling system.

FIG. 4 shows a flow chart of an enrollment portion of an authentication method.

FIG. 5 shows a flow chart of subsequent accesses using the authentication method.

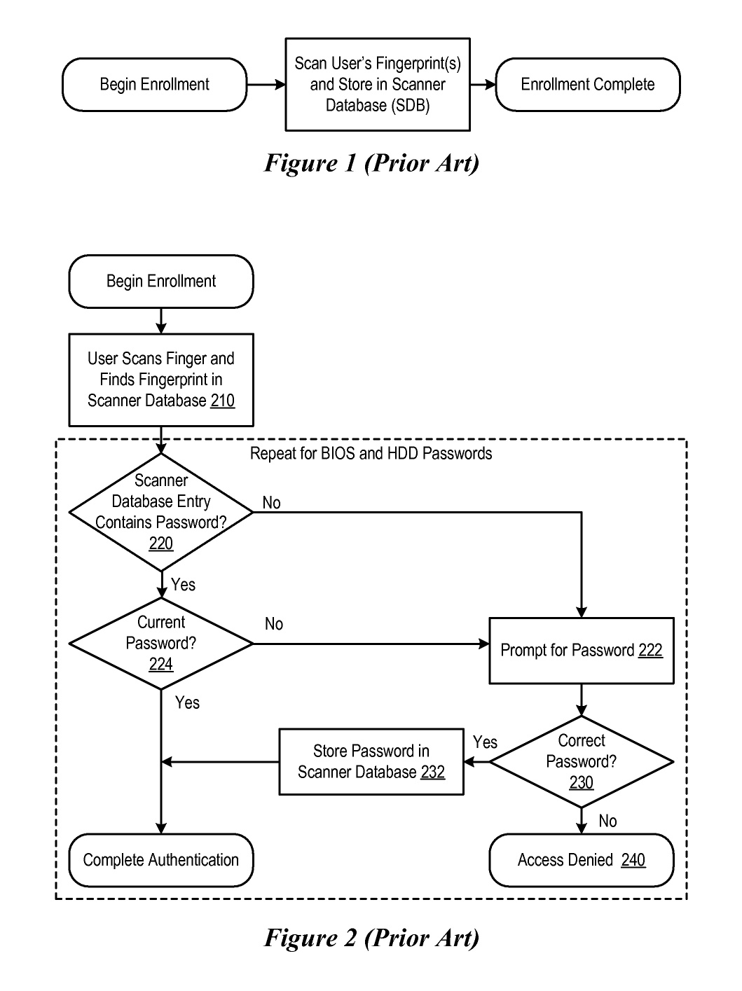

### DETAILED DESCRIPTION

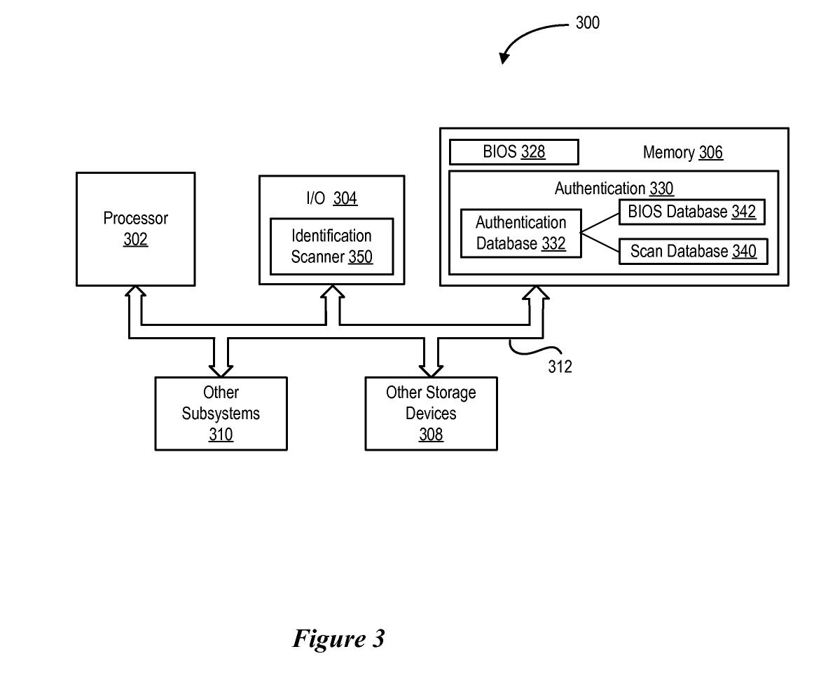

Referring briefly to FIG. 3, a system block diagram of an information handling system 300 is shown. The information handling system 300 includes a processor 302, input/output (I/O) devices 304, such as a display, a keyboard, a mouse, and associated controllers, memory 306, including volatile memory such as random access memory (RAM) and non-volatile memory such as read only memory (ROM) and hard disk drives, and other storage devices 308, such as a floppy disk and drive or CD-ROM disk and drive, and various other subsystems 310, all interconnected via one or more buses 312. The memory 306 includes a basic input output system (BIOS) 328 as well as an authentication system 330. The authentication system 330 includes an authentication database module 332. The authentication database module 332 includes a scan database 340 and a BIOS database 342. Additionally, the I/O devices 304 may include an identification scanner 350 such as a fingerprint or smart card scanner.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

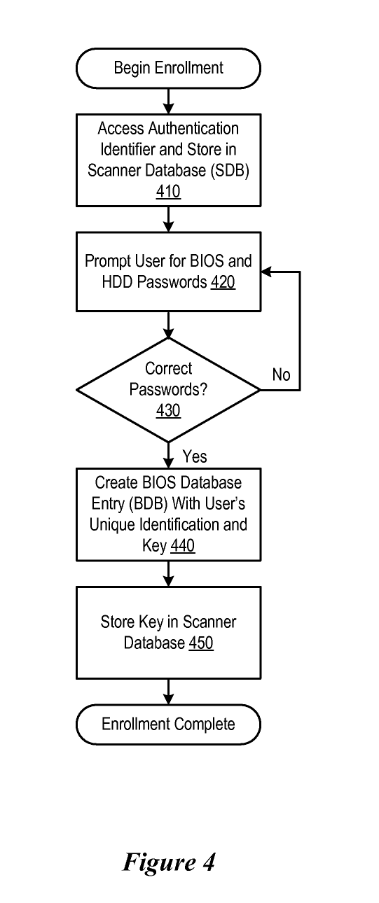

Referring to FIG. 4, a flow chart of the operation of an enrollment portion of the authentication system 330 is shown. More specifically, when a user starts the enrollment process, the authentication system 330 accesses an authentication identifier of a user (e.g., scans a user's fingerprint or fingerprints) and stores the identification information within the scan database (SDB) 340 at step 410. Next, the authentication system 330 prompts the user to enter any BIOS and HDD passwords at step 420. Depending upon the level of access that the user has to the system, the user may have both BIOS passwords as well as HDD passwords. For example, a system administrator might have both BIOS password as well as HDD passwords, while a general user might only have a HDD password. Next, the authentication system 330 determines whether the entered passwords are correct (i.e., do the passwords correspond to those expected for the particular user) at step 430. If one or more of the passwords are not correct, then the user is again prompted to enter the appropriate passwords at step 420. If the passwords are correct, then the authentication system 330 creates a BIOS database entry (BDB) which includes a unique identification and key for the user at step 440. The key is then stored within the scanner database at step 450. The key is stored within the scanner database for each individual authentication identifier. For example, each fingerprint of the user has the key associated with it. Additionally, if the user authenticates using a smart card, then this authentication identifier also has the key associated with it. After the key is associated with each authentication identifier then the operation of enrollment portion of the authentication system 330 completes.

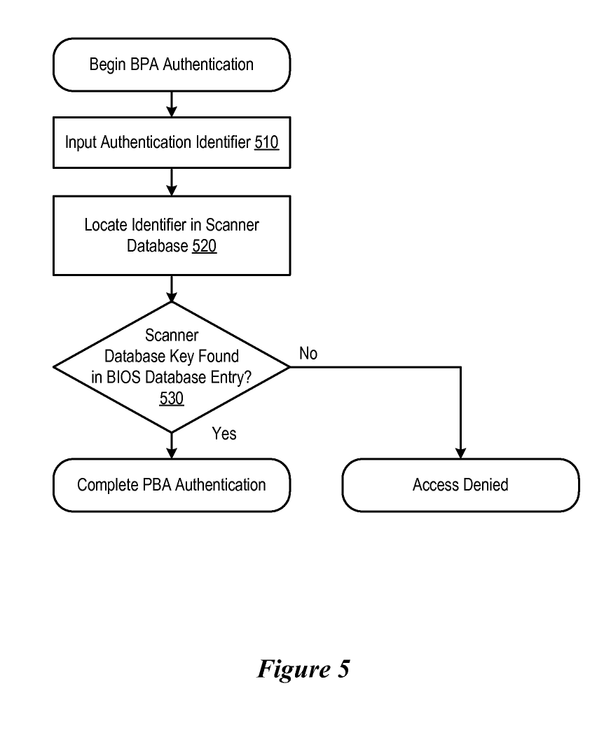

Referring to FIG. 5, a flow chart of the operation of PBA accesses to the information handling system using the authentication system 330 is shown. More specifically, the user begins the pre-boot authentication process by inputting the authentication identifier of the user at step 510. E.g., by scanning a finger print or by scanning a smart card. Next the authentication system 330 locates the identifier in the scanner database at step 520. Next, the authentication system determines whether the key that corresponds to the identifier is stored within the BIOS database at step 530. If the key is present, then the pre-boot authentication completes and access to the system is granted. If the key is not present, then access to the system is denied.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, other authentication identifiers are contemplated. For example, retinal scans, other tokens that carry information similar such as a Speedpass type token, cards with magnetic stripe, and for certain high security applications DNA information are all contemplated.

Consequently, the invention is intended to be limited only by the spirit and scope of the appended claims, giving full cognizance to equivalents in all respects.

What is claimed is:

1. An information handling system comprising:
a processor;
memory coupled to the processor;
an authentication system stored on the memory, the authentication system including an enrollment portion and an authentication portion, the enrollment portion including instructions configured to access an authentication identifier of a user;
receive a password from the user;
associate the authentication identifier with the password during enrollment; and,
store a key indicating the association within an authentication database;
the authentication portion including instructions configured to
access the authentication identifier of the user;
access the authentication database to determine whether a key indicating the association is present; and,
permit access to the information handling system when the key is present.

2. The information handling system of claim 1 wherein
the authentication database includes a scan database and a basic input output system (BIOS) database.

3. The information handling system of claim 2 wherein
the authentication identifier is stored within the scan database.

4. The information handling system of claim 2 wherein
the key is stored within the BIOS database.

5. The information handling system of claim 1 wherein
the authentication identifier includes a fingerprint.

6. The information handling system of claim 1 wherein ‘the authentication identifier includes a smart card.

7. A method for performing a pre-boot authentication process for an information handling system comprising:
performing an enrollment process on the information handling system, the enrollment process including
accessing an authentication identifier of a user;
receiving a password from the user;
associating the authentication identifier with the password during enrollment; and,
storing a key indicating the association within an authentication database; and
performing an authentication process during subsequent accesses to the information handling system, the authentication process including
accessing the authentication identifier of the user;
accessing the authentication database to determine whether a key indicating the association is present; and,
permitting access to the information handling system when the key is present.

8. The method of claim 7 wherein
the authentication database includes a scan database and a basic input output system (BIOS) database.

9. The method of claim 8 wherein
the authentication identifier is stored within the scan database.

10. The method of claim 8 wherein
the key is stored within the BIOS database.

11. The method of claim 7 wherein
the authentication identifier includes a fingerprint.

12. The method of claim 7 wherein
the authentication identifier includes a smart card.

13. An apparatus for performing a pre-boot authentication process for an information handling system comprising:
means for performing an enrollment process on the information handling system, the means for performing the enrollment process including
means for accessing an authentication identifier of a user;
means for receiving a password from the user;
means for associating the authentication identifier with the password during enrollment; and,
means for storing a key indicating the association within an authentication database; and
means for performing an authentication process during subsequent accesses to the information handling system, the means for performing the authentication process including
means for accessing the authentication identifier of the user;
means for accessing the authentication database to determine whether a key indicating the association is present; and,
means for permitting access to the information handling system when the key is present.

14. The apparatus of claim 13 wherein
the authentication database includes a scan database and a basic input output system (BIOS) database.

15. The apparatus of claim 14 wherein
the authentication identifier is stored within the scan database.

16. The apparatus of claim 14 wherein
the key is stored within the BIOS database.

17. The apparatus of claim 13 wherein
the authentication identifier includes a fingerprint.

18. The apparatus of claim 13 wherein
the authentication identifier includes a smart card.
